(19) United States
(12) Patent Application Publication
(10) Pub. No.: US 2026/0252494 A1
(43) Pub. Date: Aug. 27, 2026

(54) REDUCED TABLE FLUSH TO IMPROVE PERFORMANCE

(71) Applicant: Micron Technology, Inc., Boise, ID (US)

(72) Inventors: Zhen Gu, Shanghai (CN); Lingyun Wang, Shanghai (CN); Qingyuan Wang, Shanghai (CN)

(21) Appl. No.: 19/544,913

(22) Filed: Feb. 19, 2026

Related U.S. Application Data
(60) Provisional application No. 63/761,674, filed on Feb. 21, 2025.

(51) Int. Cl. G06F 12/10; G06F 12/0891

(52) U.S. Cl. CPC G06F 12/10; G06F 12/0891

(57) ABSTRACT

Methods, systems, and devices for reduced table flush to improve performance are described. In accordance with examples as described herein, an apparatus may be configured to implement techniques that include compressing entries in a volatile buffer that is flushed to update mapping information stored in a non-volatile memory array of the apparatus. Additionally, or alternatively, the techniques may include using a buffer list to identify uncompressed entries and determine an appropriate time to copy and/or relocate the uncompressed entries within the buffer.

### CROSS REFERENCE

The present Application for Patent claims priority to U.S. Patent Application No. 63/761,674 by Gu et al., entitled “REDUCED TABLE FLUSH TO IMPROVE PERFORMANCE,” filed February 21, 2025, which is assigned to the assignee hereof, and which is expressly incorporated by reference in its entirety herein.

### TECHNICAL FIELD

The following relates to one or more systems for memory, including reduced table flush to improve performance.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports reduced table flush to improve performance in accordance with examples as disclosed herein.

FIG. 2 shows an example memory configuration that supports reduced table flush to improve performance in accordance with examples as disclosed herein.

FIG. 3 shows an example table entry compression technique that supports reduced table flush to improve performance in accordance with examples as disclosed herein.

FIG. 4 shows an example table entry identification technique that supports reduced table flush to improve performance in accordance with examples as disclosed herein.

FIG. 5 shows table flush images of example operations that support reduced table flush to improve performance in accordance with examples as disclosed herein.

FIG. 6 shows an example flow diagram that supports reduced table flush to improve performance in accordance with examples as disclosed herein.

FIG. 7 shows a block diagram of a memory device that supports reduced table flush to improve performance in accordance with examples as disclosed herein.

### DETAILED DESCRIPTION

In some cases, an apparatus may include a host system that is in communication with a memory system (e.g., a NAND memory system). The memory system may use a table (e.g., a logic-to-physical (L2P) mapping table, among other examples) to aid in storage and/or retrieval of data stored in an array of the memory system. Information stored in the table may include logical address data, physical address data, page index data, metadata, and/or other data, among other examples. In some examples, and to allow for fast lookups and/or updates, portions of the information from the table may be temporarily stored in a buffer of the memory system.

An L2P mapping table may be quite large and may be too big for all portions to be completely and concurrently stored in a volatile buffer (e.g., a buffer in an SRAM device) associated with a non-volatile memory array (e.g., a memory array in a NAND device). In such a case, the complete L2P mapping table may be stored in the non-volatile memory array (e.g., NAND), and selected portions may be transferred to the volatile buffer when changes are made to storage locations of data in the non-volatile memory array to facilitate the apparatus performing an operation. For example, in the case of a write operation, a read operation, and/or an erase operation, a portion of the L2P mapping table corresponding to logical addressing of the non-volatile memory array being accessed by the apparatus may be transferred from the volatile buffer to the volatile memory array to facilitate the operation.

To preserve information (e.g., in the event of a power interruption or other disruptive event) and in response to trigger conditions occurring, the apparatus may perform a table flush operation that updates the L2P mapping table stored in the non-volatile memory array with updated L2P mapping information stored in the volatile buffer, including any recent changes to L2P mapping information that may be made during operation. A flush operation may refer to an operation to transfer data from the volatile memory device to the non-volatile device and thereby empty the buffer in question into the non-volatile memory device. Transferring the updated L2P mapping information (e.g., writing) to the non-volatile memory array as part of the table flush operation may be considered a background operation. If operations requested by a host system are interrupted to perform the table flush, then the memory system may reduce an overall performance of the apparatus.

In accordance with examples as described herein, an apparatus may be configured to implement techniques to reduce a quantity of table flush operations performed by an apparatus to improve a performance of the apparatus. In some examples, the techniques may include compressing entries in a volatile buffer that refer to a set of sequentially indexed address information and excluding the entries from a range of information (e.g., of updated L2P mapping information) that is flushed to a non-volatile memory array of the apparatus. Additionally, or alternatively, the techniques may include using a buffer list to identify uncompressed entries in the volatile buffer and determine an appropriate time to copy and/or relocate the uncompressed entries within the buffer.

Using such techniques, a quantity of flush operations performed by the apparatus may be decreased. By decreasing the quantity of flush operations, interruptions to the host system may be reduced to realize an increased performance (e.g., an effective speed of the host system writing to the memory system may be increased).

In addition to applicability in memory systems as described herein, techniques for reducing table flush to improved performance may be generally implemented to support edge computing applications. Edge computing is a distributed computing paradigm that brings computation and data storage closer to the sources of data than traditional cloud services. As the use of edge computing to provide computing, storage, and networking services at locations that are geographically closer to end users increases, many devices and systems may benefit from improved processing, performance, and storage at edge devices. For example, increasing memory density, storage capacity, and processing power of edge devices may decrease a reliance on the devices to remote computing or devices, which may otherwise increase latency of operations performed at the devices. Implementing the techniques described herein may support edge computing techniques by improving memory access speeds at edge computing devices and/or improving response times associated with edge computing devices, among other benefits.

Features of the disclosure are illustrated and described in the context of systems, devices, and circuits. Features of the disclosure are further illustrated and described in the context of a memory configuration including a buffer storing table entries (e.g., L2P mapping information), techniques that may compress one or more of the table entries, techniques that may identify one or more of the table entries, table flush images, and/or flowcharts.

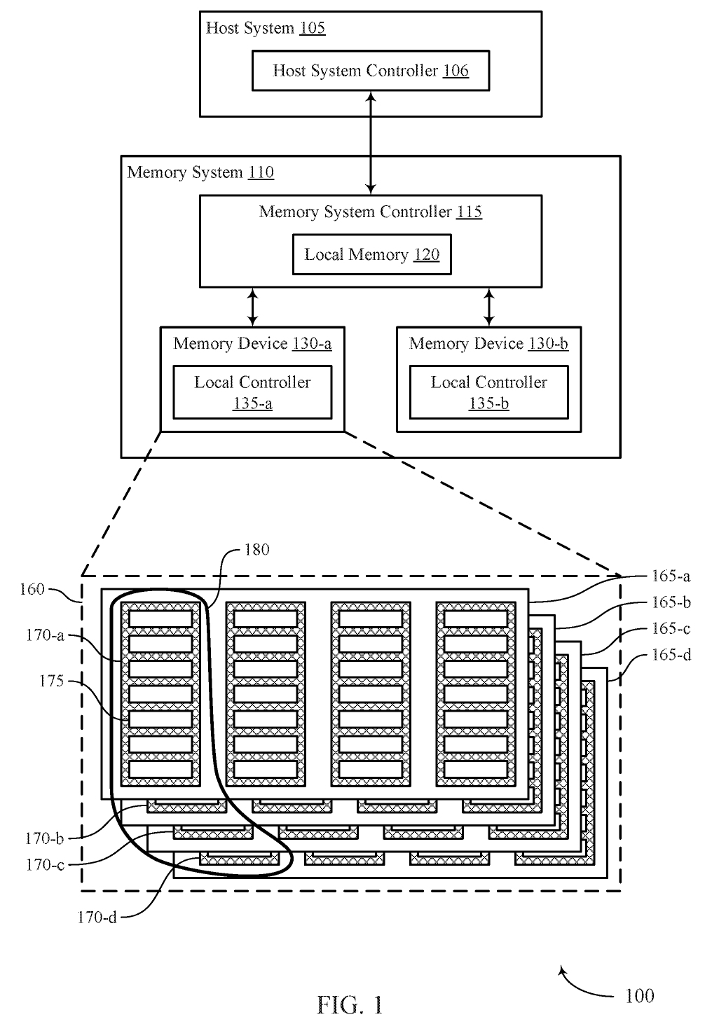

FIG. 1 shows an example of a system 100 that supports reduced table flush to improve performance in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses (PBAs)) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

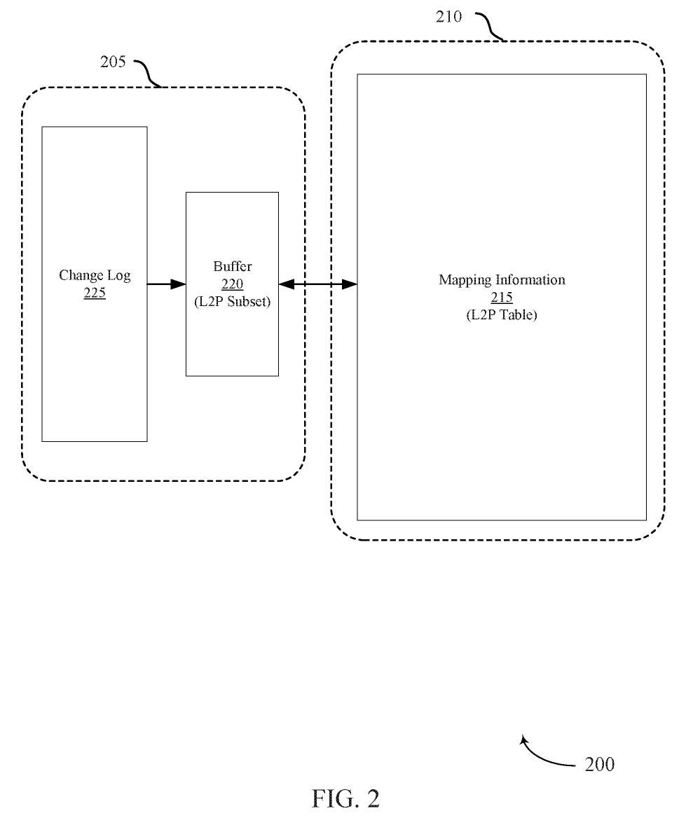

In some examples, and as described in greater detail in connection with FIGS. 2 through 7, the system 100 may include a non-volatile memory device (e.g., a static random access memory (SRAM) device) that includes a change log and one or more buffers that assist in maintaining the L2P mapping tables. The change log may record changes to L2P mapping information as a result of a command from a controller (e.g., the host system controller 106, the memory system controller 115, and/or the local controller 135). The one or more buffers may be used to store the changes and facilitate operation of the system 100 while deferring changes to an L2P mapping table that may be stored in a block 170 (e.g., in a memory array).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media (CRM) that support reduced table flush to improve performance. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some examples, the non-transitory CRM may cause processing circuitry of the system 100 (e.g., the host system controller 106, the memory system controller 115, and/or a local controller 135) to perform a series of operations related to managing an L2P table stored in memory device 130 (e.g., in the block 170). As described in greater detail in connection with FIGS. 2 through 7, such operations may include the system 100 transferring a portion of the L2P table to a buffer. Additionally, or alternatively, and in response to performing an operation that updates a change log and triggers a mapping update, the operations may include the system 100 updating an entry in the buffer. Additionally, or alternatively, the operations may include the system 100 using a buffer list to identify the entry.

FIG. 2 shows an example memory configuration 200 that supports reduced table flush to improve performance in accordance with examples as disclosed herein. As shown in FIG. 2, the memory configuration 200 includes a volatile device 205 and a non-volatile device 210. As examples, the volatile device 205 may be an SRAM memory device and the non-volatile device 210 may be a NAND memory device (e.g., the memory device 130 of FIG. 1).

In some examples, the memory configuration 200 may be used to manage mapping information 215 stored in an array of the non-volatile device 210 (e.g., in a block 170 as described in connection with FIG. 1). The mapping information 215 may be L2P mapping information (e.g., table entries in an L2P mapping table) and include LBAs, PBAs, and/or metadata, among other examples. The mapping information 215 may be arranged as a set of data structures that define a relationship between the LBAs and the PBAs.

As shown in FIG. 2, the volatile device 205 includes a buffer 220 and a change log 225. In some examples, the buffer 220 may store table entries corresponding to a subset of the mapping information 215, thereby allowing a system including the non-volatile device 210 (e.g., the memory system 110 of FIG. 1) to efficiently locate and access data within the non-volatile device 210.

The change log 225 may maintain a sequential history of changes to the mapping information 215 that result from commands issued by a controller (e.g., the host system controller 106, the memory system controller 115, and/or the local/controller 135 described in connection with FIG. 1). Commands that may trigger changes to the mapping information 215 include write commands, erase commands, garbage collection commands, wear leveling commands, trim commands, error recovery commands, restore commands, and/or system optimization commands, among other examples.

To preserve information (e.g., in the event of a power interruption or other disruptive event) and for conditions (e.g., a storage capacity of the buffer 220 being reached and/or exceeded), the system including the memory configuration 200 may perform a table flush operation that updates the mapping information 215 stored in the non-volatile device 210 with updated mapping information stored in the buffer 220 (e.g., table entries received into the buffer 220 from the change log 225). Transferring the updated mapping information to the non-volatile device 210 as part of the table flush operation may be considered a background operation and, in some implementations, interrupt an operation requested by a controller, thereby reducing a performance of the system.

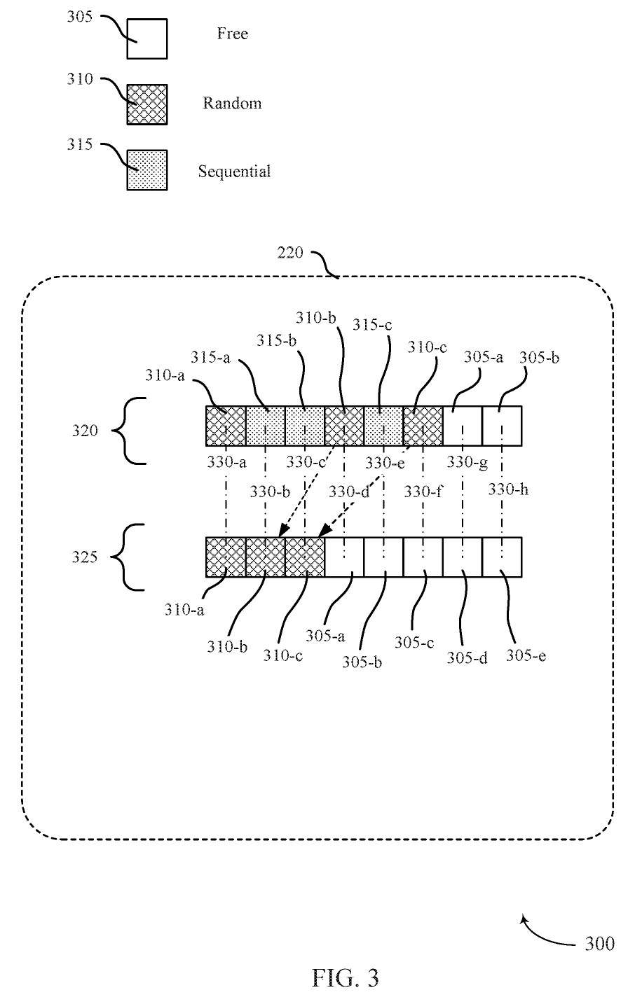

As described in greater detail in connections with FIGS. 3 through 7, a system including the memory configuration 200 may utilize one or more techniques to mitigate conditions that trigger a table flush operation, thereby reducing a likelihood and/or a frequency of table flush operations. Such techniques may include at least one controller (e.g., the host system controller 106, the memory system controller 115, and/or the local/controller 135 described in connection with FIG. 1) executing instructions stored in a non-transitory CRM to compress a table entry in the buffer 220, relocate a table entry in the buffer 220, and/or identify a table entry in the buffer 220 using a buffer list. Additionally, or alternatively, such techniques may be performed dynamically (e.g., continuously and/or in real time). Additionally, or alternatively, such techniques may be extended and applicable to table entries that are stored in the change log 225 and/or being written from the change log to the buffer 220.

FIG. 3 shows an example table entry compression technique 300 that supports reduced table flush to improve performance in accordance with examples as disclosed herein. In some examples, an apparatus (e.g., the system 100 of FIG. 1, including the host system 105 and the memory system 110) may apply the table entry compression technique 300 to compress and/or relocate table entries stored in a volatile buffer (the buffer 220 described in connection with FIG. 2).

FIG. 3 shows example types of table entries (e.g., types of information) that may be stored in the buffer 220, including a table entry 305 (e.g., table entries 305-a, 305-b, 305-c, 305-d, 305-e) that includes free information (e.g., an L2P table entry that may be empty, allocated, and/or void of valid information), a table entry 310 that includes random information (e.g., an L2P table entry including at least one address that is random relative to a preceding address) and a table entry 315 that includes sequential information (e.g., an L2P table entry that may include sequentially-indexed addresses relative to a preceding address). The buffer 220 may store the table entries (e.g., specific permutations of the table entry 305, the table entry 310, and/or the table entry 315 related to a specific memory access operation) in slot locations 330 that correspond to physical locations (e.g., a combination of one or more rows and/or columns of memory cells) across the buffer 220.

FIG. 3 further shows an example uncompressed state 320 and an example compressed state 325 of the buffer 220. The uncompressed state 320 may correspond to a state of the buffer 220 during and/or subsequent to an initialization sequence that populates the buffer 220 with a subset of L2P mapping information (e.g., a subset of the mapping information 215 described in connection with FIG. 2). The compressed state 325 may correspond to a state of the buffer 220 after at least one controller (e.g., the host system controller 106, the memory system controller 115, and/or the local/controller 135 described in connection with FIG. 1) executes instructions stored in a non-transitory CRM to compress and/or relocate table entries in the buffer 220, effective to consume less storage capacity than the uncompressed state 320.

In some examples, the controller may execute the instructions dynamically. In other examples, the controller may execute the instructions as part of updating the buffer 220 with table entries from a change log (e.g., the change log 225 as described in connection with FIG. 2).

In some examples, the controller may determine whether to compress an entry stored in a slot location of the buffer 220. For example, and as shown in FIG. 3, the controller may determine to compress the table entry 315-a stored in slot location 330-b, to compress the table entry 315-b stored in slot location 330-c, and to compress the table entry 315-c stored in slot location 330-e. Said another way, the controller may determine whether to compress table entries based on the table entries including sequential information.

Additionally, or alternatively, and as part of table entry compression technique 300, the controller may determine to relocate an uncompressed table entry to a slot as a result of other table entries being compressed. For example, and as shown in FIG. 3, the controller may determine to relocate the table entry 310-b from the slot location 330-d to the slot location 330-b immediately subsequent to the slot location 330-a where the table entry 310-a is located, and further determine to relocate the table entry 310-c from the slot location 330-f to the slot location 330-c. Slot locations 330-g and 330-h may have table entries 305 with free information. Said another way, the controller may determine to relocate table entries that include random information to slots that may have included sequential information (since compressed).

In some examples, and as shown in FIG. 3, relocating table entries may include relocating two or more table entries to slots that are immediately adjacent to one another. Additionally, or alternatively, and in other examples, relocating a table entry may include relocating the table entry to a slot that is immediately adjacent to a “native” table entry that the controller determined not to compress.

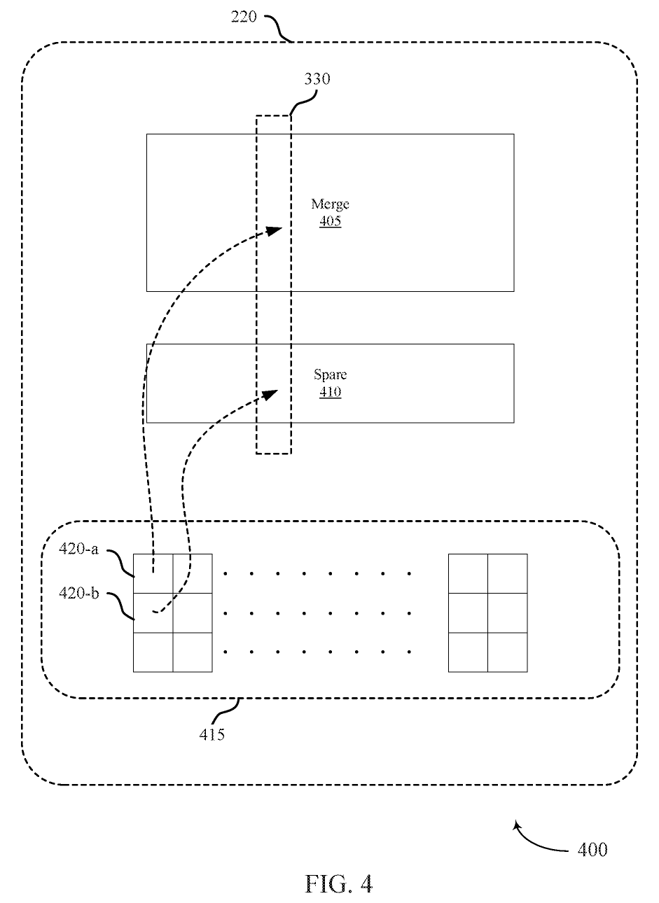

In some examples, the table entry compression technique 300 may increase a quantity and/or a capacity of slot locations in the buffer 220 that are available to store mapping updates from a change log (e.g., updated L2P table entries from the change log 225 described in connection with FIG. 2). Furthermore, the table entry compression technique 300 may, alone or in combination with other techniques described in connection with FIGS. 4 through 7, avert and/or delay a table flush operation from the buffer 220 to reduce a quantity of flush operations performed by an apparatus, thereby increasing a performance of the apparatus.

FIG. 4 shows an example table entry identification technique 400 that supports reduced table flush to improve performance in accordance with examples as disclosed herein. In some examples, an apparatus (e.g., the system 100 of FIG. 1, including the host system 105 and the memory system 110) may apply the table entry identification technique 400 to identify table entries stored in a volatile buffer (the buffer 220 described in connection with FIG. 2).

As shown in FIG. 4, and in some examples, the buffer 220 includes a merge allocation 405 and a spare allocation 410. In some examples, the merge allocation 405 may store primary L2P mapping information (e.g., LBA information and PBA information) used by the apparatus during a memory access operation, and the spare allocation 410 may store auxiliary L2P mapping information (e.g., metadata) and/or overflow information received from the merge allocation 405 during an updating of entries in the buffer 220 received from a change log (e.g., received from the change log 225 as described in connection with FIG. 2). As further shown in FIG. 4, a slot location 330 in the buffer 220 may include a respective portion of the merge allocation 405 paired with a respective portion of the spare allocation 410. In some examples, and to store an amount of primary L2P mapping information sufficient for operation of the apparatus, the respective portion of a merge allocation 405 (that is paired with the respective portion of the spare allocation 410) may have a storage capacity of approximately 4 kilobytes (4Kbyte). However, other capacities for the merge allocation 405 are within the scope of the present disclosure.

FIG. 4 further includes a buffer list 415. As shown in FIG. 4 and in some examples, the buffer list 415 may be augmented with the merge allocation 405 and/or the spare allocation 410 within the buffer 220. In other examples, the buffer list 415 may be separate from the buffer 220 and within a memory device including the buffer 220 (e.g., be included in a portion of the volatile device 205 that does not include the merge allocation 405 and/or the spare allocation 410). Additionally, or alternatively, and in other examples, at least a portion of the buffer list 415 may be within another memory device (e.g., a memory device other than the volatile device 205).

The buffer list 415 may store information from a collection of one or more buffers of the apparatus (e.g., including information from the buffer 220). Such information may be hierarchical and include offset information 420 that indicates a logical relationship between data stored in the buffer 220 (and/or other buffers) and a corresponding position of the data in an L2P mapping (e.g., the mapping information 215 described in connection with FIG. 2). The offset information 420 may include a logical offset that identifies a starting LBA, a physical offset that identifies a starting PBA, a length or range that indicates a quantity of table update entries, and/or a timestamp, among other examples.

As part of the table entry identification technique 400, at least one controller (e.g., the host system controller 106, the memory system controller 115, and/or the local/controller 135 described in connection with FIG. 1) may execute instructions stored in a non-transitory CRM to pair information stored in the buffer list 415 with information stored in the slot location 330. For example, and as shown in FIG. 4, the controller may execute instructions stored in the non-transitory CRM to pair the offset information 420-a with primary L2P mapping information stored in the merge allocation 405 of slot location 330, and pair the offset information 420-b with auxiliary L2P mapping information stored in the spare allocation 410 of slot location 330.

In this way, the controller may use the buffer list to identify L2P mapping information and avert relocating a table entry in the buffer 220 (e.g., a table entry 310 including random information that may be a candidate for relocation as part of the table entry compression technique 300 described in connection with FIG. 3) until a suitable time that does not interrupt and/or compromise a performance of the apparatus. Additionally, or alternatively and by averting relocating the table entry, the table entry identification technique 400 may circumvent potentially unnecessary writing and/or copy times associated with relocating the table entry to improve an overall performance of the apparatus. Additionally, or alternatively and at a suitable time that does not interrupt and/or compromise a performance of the apparatus, the controller may relocate the table entry in the buffer 220.

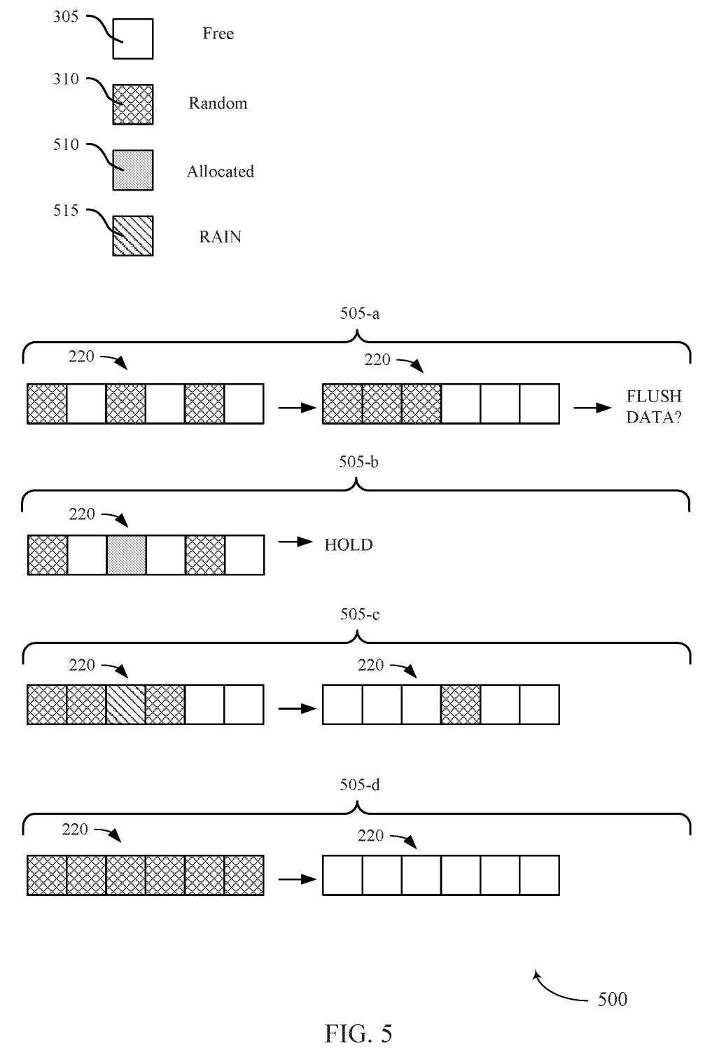

FIG. 5 shows example table images 500 that support reduced table flush to improve performance in accordance with examples as disclosed herein. The table images 500 may include flush transition images 505 of a subset of an L2P table flushed from the buffer 220 as described in connection with FIGS. 1 through 4 and elsewhere herein.

In addition to table entry 305 (e.g., an L2P table entry that may be empty and/or void of valid information) and table entry 310 that includes random information (e.g., an L2P table entry including random addresses that are not sequentially indexed), FIG. 5 references a table entry 510 (e.g., an allocated table entry that is active and/or reserved, but includes information in an invalidated state) and table entry 515 (e.g., a table entry that includes redundant array of independent NAND (RAIN) information used to enhance reliability, durability, and error resilience in a memory system). In some examples, the table entry 515 (e.g., RAIN information) may be associated with a parity consistency requirement and/or an error recovery condition that triggers a table flush operation.

As part of FIG. 5, the flush transition image 505-a shows stages of an example table flush operation including a stage during which the buffer 220 includes multiple table entries 310 (e.g., random information) that have not been relocated within the buffer 220. In some examples, and as part of managing the table flush operation, a controller (e.g., the host system controller 106, the memory system controller 115, and/or the local/controller 135 described in connection with FIG. 1) may determine to relocate one or more table entries 310 using aspects of the table entry compression technique 300 described in connection with FIG. 3 and/or aspects of the table entry identification technique 400 described in connection with FIG. 4. Additionally, or alternatively, and after determining to relocate one or more of the table entries 310, the controller may determine whether to flush the information (e.g., data) based on a storage capacity threshold of the buffer 220 being satisfied, among other examples. In some examples, such a storage capacity threshold may correspond to a partial storage capacity of the buffer 220.

Furthermore, and as part of FIG. 5, the flush transition image 505-b shows a stage of an example table flush operation during which the buffer 220 includes one or more table entries 310 (e.g., subsequent to performing one or more aspects of the table entry compression technique 300) and the table entry 510 (e.g., an allocated table entry that includes information in an invalidated state). In some examples, and as part of managing the table flush operation, the controller may determine to pause and/or hold the table flush operation until the controller validates the information (e.g., confirms the information is “ready” to flush from the buffer 220). Validating the information may include the controller executing instructions stored in a non-transitory CRM to determine that the information is complete and/or to perform a parity check that confirms the information is without error. Additionally, or alternatively, validating the information may include the controller receiving an indication from another controller that the information is valid, among other examples.

Furthermore, and as part of FIG. 5, the flush transition image 505-c shows stages of an example table flush operation including a stage during which the buffer 220 includes one or more table entries 310 (e.g., subsequent to performing one or more aspects of the table entry compression technique 300) and the table entry 515 (e.g., RAIN information). In some examples, and as part of managing the table flush operation, the controller may determine to flush at least a portion of the buffer 220 based on the buffer, including the table entry 515.

Furthermore, and as part of FIG. 5, the flush transition image 505-d shows stages of an example table flush operation including a stage during which the buffer 220 includes one or more table entries 310 (e.g., subsequent to performing one or more aspects of the table entry compression technique 300). In some examples, and as part of managing the table flush operation, the controller may determine to flush an entirety of the buffer 220 based on contents of the buffer 220 (e.g., the table entries 310) being valid and/or a storage capacity threshold of the buffer 220 being satisfied, among other examples. In some examples, such a storage capacity threshold may correspond to an entire storage capacity of the buffer 220.

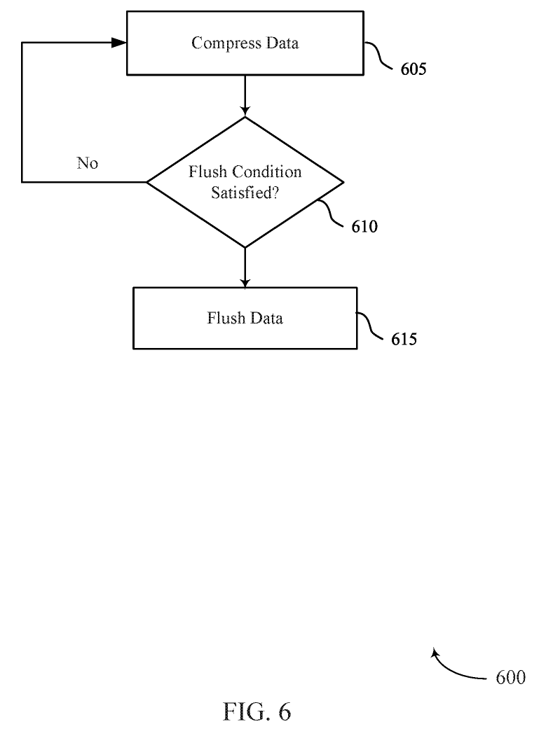

FIG. 6 shows an example flow diagram 600 that supports reduced table flush to improve performance in accordance with examples as disclosed herein. The flow diagram 600 is performed by an apparatus including a controller, a volatile buffer, and a non-volatile memory array. In some examples, the apparatus may correspond to the system 100 of FIG. 1.

At 605, data is compressed by the apparatus. Compressing the data may include rearranging data stored in a volatile buffer into a compressed state that consumes less storage capacity of the volatile buffer. In some examples, the data may be a subset of mapping information (e.g., one or more entries of an L2P table) stored in the non-volatile memory array. Additionally, or alternatively, and in some examples, the data may be updated mapping information received from a change log.

At 610, it may be determined whether a condition to flush the volatile buffer is satisfied. In some examples, the condition may correspond to a threshold related to a storage capacity of the volatile buffer being satisfied. If the condition is satisfied, the flow proceeds to 615. If the condition is not satisfied, then other parts of the flow may occur and data may continue to be compressed.

At 615, a flush operation may be performed. The flush operation may transfer data from the volatile buffer to the non-volatile memory array. In some examples, the flush operation may update the mapping information stored in the non-volatile memory array. Additionally, or alternatively, and in some examples, that flush operation may exclude transferring the data in the compressed state.

In some examples, the data may be compressed by the controller executing a first set instructions stored in a non-transitory CRM. Additionally, or alternatively, and in some examples, the condition may be determined to be satisfied by the controller executing a second set of instructions stored in the non-transitory CRM. Additionally, or alternatively, and in some examples, the flush operation may be performed by the controller executing a third set of instructions stored in the non-transitory CRM.

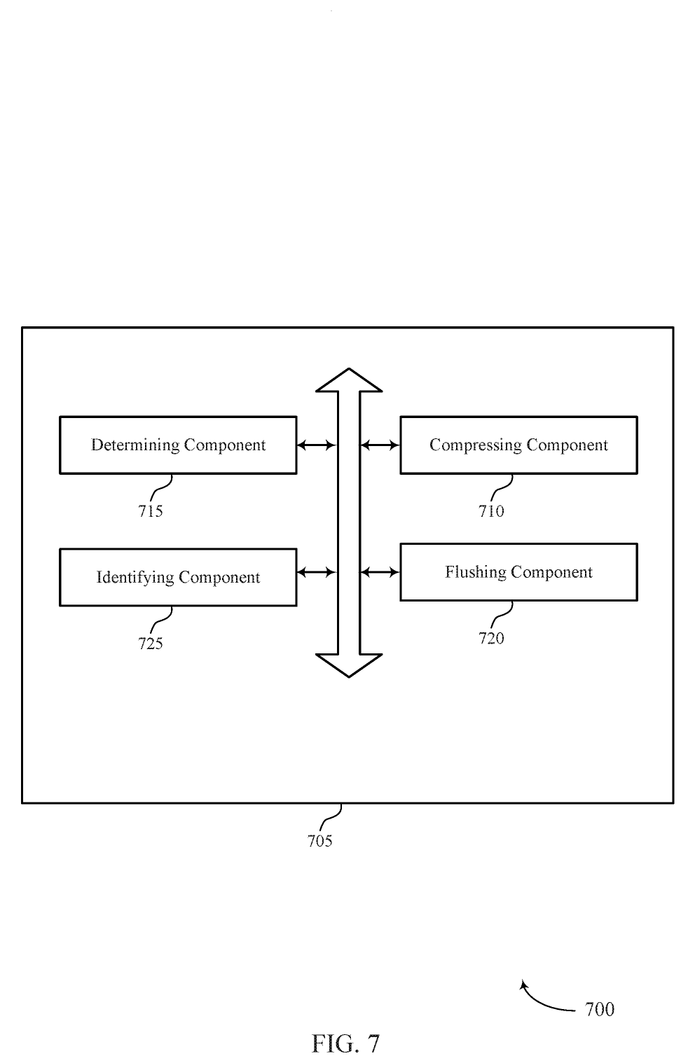

FIG. 7 shows a block diagram 700 of an apparatus 705 that supports reduced table flush to improve performance in accordance with examples as disclosed herein. The apparatus 705 may be an example of aspects of an apparatus as described with reference to FIGS. 1 through 6. The apparatus 705, or various components thereof, may be an example of means for performing various aspects of reduced table flush to improve performance as described herein. For example, the apparatus 705 may include a compressing component 710, a determining component 715, a flushing component 720, an identifying component 725, or any combination thereof. Each of these components, or components of subcomponents thereof (e.g., one or more processors, one or more memories), may communicate, directly or indirectly, with one another (e.g., via one or more buses).

The apparatus 705 may be configured as or otherwise support a means for transferring a portion of a logical-to-physical mapping stored in a memory array of a non-volatile device of the semiconductor system to a buffer stored in a volatile device of the semiconductor system. In some examples, the apparatus 705 may be configured as or otherwise support a means for in response to performing an operation that updates a change log and triggers a mapping update, update an entry in the buffer. In some examples, the apparatus 705 may be configured as or otherwise support a means for identifying the entry in the buffer using a buffer list.

In some examples, the instructions are further executable to cause the semiconductor system to determine whether information in the entry includes sequentially indexed addresses. In some examples, the instructions are further executable to cause the semiconductor system to compress the entry, based in least in part on determining that information includes sequentially indexed addresses.

In some examples, the instructions are further executable to cause the semiconductor system to in response to performing a second operation that updates the change log and triggers a second mapping update, update a second entry in the buffer. In some examples, the instructions are further executable to cause the semiconductor system to compress the second entry.

In some examples, the instructions are further executable to cause the semiconductor system to relocate information that identifies the entry within the buffer list without relocating the entry in the buffer.

In some examples, the instructions are further executable to cause the semiconductor system to relocate information that identifies the entry within the buffer list at a first time without relocating the entry in the buffer. In some examples, the instructions are further executable to cause the semiconductor system to relocate the entry in the buffer at a second time.

In some examples, the instructions are further executable to cause the semiconductor system to pair first information in a merge allocation of the buffer with a second information in a spare allocation of the buffer using the buffer list.

The compressing component 710 may be configured as or otherwise support a means for performing a data compression operation that rearranges data stored in a volatile buffer into a compressed state that consumes less storage capacity of the volatile buffer. The determining component 715 may be configured as or otherwise support a means for determining whether a condition to flush the volatile buffer is satisfied. The flushing component 720 may be configured as or otherwise support a means for in response to determining that the condition is satisfied, performing a flush operation that excludes the data in the compressed state from a flush range used to update a logical-to-physical mapping that is stored in a non-volatile memory array.

In some examples, determining whether the condition to flush the volatile buffer is satisfied includes determining that the volatile buffer is full.

In some examples, the data is first data and determining whether the condition to flush the volatile buffer is satisfied includes determining that the volatile buffer does not include any second data that is not valid.

In some examples, the data is first data and performing the flush operation includes performing a flush operation that transfers second data that is not in the compressed state from the volatile buffer to update the logical-to-physical mapping stored in the non-volatile memory array.

In some examples, the identifying component 725 may be configured as or otherwise support a means for identifying second data in a second slot location of the volatile buffer using a buffer list to avert the second data from being relocated to the first slot location.

In some examples, performing the flush operation includes performing a flush operation that transfers redundant array of independent NAND data from the volatile buffer to update the logical-to-physical mapping stored in the non-volatile memory array.

In some examples, the described functionality of the apparatus 705, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the apparatus 705, or various components thereof, may be implemented at least in part by instructions (e.g., stored in memory, non-transitory computer-readable medium) executable by such at least one processor.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 1: A memory system, including: a non-volatile memory device configured to store a logical-to-physical mapping; a volatile memory device including a buffer that is configured to store a subset of the logical-to-physical mapping; and processing circuitry coupled with the non-volatile memory device and the volatile memory device and configured to cause the memory system to: determine whether to compress a first entry stored in a first slot location of the buffer; compress the first entry stored in the first slot location of the buffer and relocate a second entry stored in a second slot location of the buffer to the first slot location based at least in part on determining to compress the first entry; receive a command that updates the second slot location with a third entry; and in response to receiving a flush command, update the logical-to-physical mapping using the subset, including the second entry stored in the first slot location and the third entry stored in the second slot location.

Aspect 2: The memory system of aspect 1, where the processing circuitry is further configured to cause the memory system to: determine to compress the first entry based at least in part on the first entry including sequentially indexed addresses.

Aspect 3: The memory system of any of aspects 1 through 2, where the processing circuitry is further configured to cause the memory system to: determine to retain the second entry prior to relocating the second entry based at least in part on the second entry including information that is a random address relative to a preceding address.

Aspect 4: The memory system of any of aspects 1 through 3, where the volatile memory device further includes a change log and the processing circuitry is further configured to cause the memory system to: compress a fourth entry in the change log prior to transferring the fourth entry, in a compressed state, from the change log to the buffer.

Aspect 5: The memory system of any of aspects 1 through 4, where the processing circuitry is further configured to cause the memory system to: determine to retain a fourth entry in a third slot location between the first slot location and the second slot location based at least in part on the fourth entry including addresses that are not sequentially indexed.

Aspect 6: The memory system of any of aspects 1 through 5, where the second slot location is immediately adjacent to the first slot location.

Aspect 7: The memory system of any of aspects 1 through 6, where the processing circuitry is further configured to cause the memory system to: identify, using a buffer list, the second entry stored in the first slot location and the third entry stored in the second slot location.

Aspect 8: The memory system of aspect 7, where the first slot location and the second slot location each include a respective merge allocation paired with a respective spare allocation.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
a non-volatile memory device configured to store a logical-to-physical mapping;
a volatile memory device comprising a buffer that is configured to store a subset of the logical-to-physical mapping; and
processing circuitry coupled with the non-volatile memory device and the volatile memory device and configured to cause the memory system to:
determine whether to compress a first entry stored in a first slot location of the buffer;
compress the first entry stored in the first slot location of the buffer and relocate a second entry stored in a second slot location of the buffer to the first slot location based at least in part on determining to compress the first entry;
receive a command that updates the second slot location with a third entry; and
in response to receiving a flush command, update the logical-to-physical mapping using the subset, including the second entry stored in the first slot location and the third entry stored in the second slot location.

2. The memory system of claim 1, wherein the processing circuitry is further configured to cause the memory system to:
determine to compress the first entry based at least in part on the first entry including sequentially indexed addresses.

3. The memory system of claim 1, wherein the processing circuitry is further configured to cause the memory system to:
determine to retain the second entry prior to relocating the second entry based at least in part on the second entry including information that is a random address relative to a preceding address.

4. The memory system of claim 1, wherein the volatile memory device further comprises a change log and the processing circuitry is further configured to cause the memory system to:
compress a fourth entry in the change log prior to transferring the fourth entry, in a compressed state, from the change log to the buffer.

5. The memory system of claim 1, wherein the processing circuitry is further configured to cause the memory system to:
determine to retain a fourth entry in a third slot location between the first slot location and the second slot location based at least in part on the fourth entry including addresses that are not sequentially indexed.

6. The memory system of claim 1, wherein the second slot location is immediately adjacent to the first slot location.

7. The memory system of claim 1, wherein the processing circuitry is further configured to cause the memory system to:
identify, using a buffer list, the second entry stored in the first slot location and the third entry stored in the second slot location.

8. The memory system of claim 7, wherein the first slot location and the second slot location each include a respective merge allocation paired with a respective spare allocation.

9. A non-transitory computer-readable medium storing code comprising instructions which, when executed by processing circuitry of a semiconductor system, cause the semiconductor system to:
transfer a portion of a logical-to-physical mapping stored in a memory array of a non-volatile device of the semiconductor system to a buffer stored in a volatile device of the semiconductor system;
in response to performing an operation that updates a change log and triggers a mapping update, update an entry in the buffer; and
identify the entry in the buffer using a buffer list.

10. The non-transitory computer-readable medium of claim 9, wherein the instructions are further executable to cause the semiconductor system to:
determine whether information in the entry includes sequentially indexed addresses; and
compress the entry, based in least in part on determining that information includes sequentially indexed addresses.

11. The non-transitory computer-readable medium of claim 9, wherein the entry is a first entry, the operation is a first operation, the mapping update is a first mapping update, and the instructions are further executable to cause the semiconductor system to:
in response to performing a second operation that updates the change log and triggers a second mapping update, update a second entry in the buffer; and
compress the second entry.

12. The non-transitory computer-readable medium of claim 9, wherein the instructions are further executable to cause the semiconductor system to relocate information that identifies the entry within the buffer list without relocating the entry in the buffer.

13. The non-transitory computer-readable medium of claim 9, wherein the instructions are further executable to cause the semiconductor system to:
relocate information that identifies the entry within the buffer list at a first time without relocating the entry in the buffer; and
relocate the entry in the buffer at a second time.

14. The non-transitory computer-readable medium of claim 9, wherein the instructions are further executable to cause the semiconductor system to pair first information in a merge allocation of the buffer with a second information in a spare allocation of the buffer using the buffer list.

15. A method at a memory system, comprising:
performing a data compression operation that rearranges data stored in a volatile buffer into a compressed state that consumes less storage capacity of the volatile buffer;
determining whether a condition to flush the volatile buffer is satisfied; and
in response to determining that the condition is satisfied, performing a flush operation that excludes the data in the compressed state from a flush range used to update a logical-to-physical mapping that is stored in a non-volatile memory array.

16. The method of claim 15, wherein determining whether the condition to flush the volatile buffer is satisfied includes determining that the volatile buffer is full.

17. The method of claim 15, wherein the data is first data and determining whether the condition to flush the volatile buffer is satisfied includes determining that the volatile buffer does not include any second data that is not valid.

18. The method of claim 15, wherein the data is first data and performing the flush operation includes performing a flush operation that transfers second data that is not in the compressed state from the volatile buffer to update the logical-to-physical mapping stored in the non-volatile memory array.

19. The method of claim 15, wherein the data is first data that is located in a first slot location and further comprising:
identifying second data in a second slot location of the volatile buffer using a buffer list to avert the second data from being relocated to the first slot location.

20. The method of claim 15, wherein performing the flush operation includes performing a flush operation that transfers redundant array of independent NAND data from the volatile buffer to update the logical-to-physical mapping stored in the non-volatile memory array.
